(19) United States
(12) Patent Application Publication
(10) Pub. No.: US 2018/0152830 A1
(43) Pub. Date: May 31, 2018

(54) INFORMATION RECEPTION TERMINAL AND INFORMATION DISTRIBUTION SYSTEM

(71) Applicant: FUJITSU LIMITED, Kawasaki-shi (JP)

(72) Inventor: Yohei Seki, Kawasaki (JP)

(73) Assignee: FUJITSU LIMITED, Kawasaki-shi (JP)

(21) Appl. No.: 15/801,455

(22) Filed: Nov. 2, 2017

(30) Foreign Application Priority Data
Nov. 25, 2016 (JP) 2016-229529

(51) Int. Cl. H04W 8/00; H04L 29/04

(52) U.S. Cl. CPC H04W 8/005; H04L 61/2007; H04L 29/04

(57) ABSTRACT

An information reception terminal includes a processor configured to acquire meta information from each of a plurality of information distribution terminals existing within a communication range of the information reception terminal. The meta information includes identification information identifying a content distributed by the relevant information distribution terminal. The processor is configured to generate a list of contents on the basis of the meta information acquired from each of the plurality of information distribution terminals. The processor is configured to display the generated list on a display device. the processor is configured to select a content distributed by one of different information distribution terminals of the plurality of information distribution terminals to list the selected content in the list when there are identical contents identified by the same identification information included in first pieces of meta information acquired from the different information distribution terminals.

### CROSS-REFERENCE TO RELATED APPLICATION

This application is based upon and claims the benefit of priority of the prior Japanese Patent Application No. 2016-229529, filed on Nov. 25, 2016, the entire contents of which are incorporated herein by reference.

### FIELD

The embodiment discussed herein is related to an information reception terminal and an information distribution system.

### BACKGROUND

There is a content distribution service that distributes contents such as videos between wireless terminals. In an art related to the content distribution, context information including a content transmittable time zone and meta information of a distributable content is acquired from a content transmission terminal, and context information including a content receivable time zone and meta information of a content required to be distributed is acquired from a content reception terminal. Then, a content transmission terminal that is capable of distributing contents to the content reception terminal is extracted, and a control is made such that a content distribution request is transmitted to the extracted content transmission terminal.

Related technologies are disclosed in, for example, Japanese Laid-Open Patent Publication No. 2011-14022.

### SUMMARY

According to an aspect of the present invention, provided is an information reception terminal including a memory and a processor coupled to the memory. The processor is configured to acquire meta information from each of a plurality of information distribution terminals existing within a communication range of the information reception terminal. The meta information includes identification information identifying a content distributed by the relevant information distribution terminal. The processor is configured to generate a list of contents on the basis of the meta information acquired from each of the plurality of information distribution terminals. The processor is configured to display the generated list on a display device. the processor is configured to select a content distributed by one of different information distribution terminals of the plurality of information distribution terminals to list the selected content in the list when there are identical contents identified by the same identification information included in first pieces of meta information acquired from the different information distribution terminals.

The object and advantages of the disclosure will be realized and attained by means of the elements and combinations particularly pointed out in the claims. It is to be understood that both the foregoing general description and the following detailed description are exemplary and explanatory and are not restrictive of the disclosure, as claimed.

The above-described related art has a problem in that, for example, when there are a plurality of content transmission terminals, which have identical contents, in a communication range of the content reception terminal, the identical contents are redundantly displayed on the content reception terminal.

FIGS. 11A and 11B are diagrams illustrating the display of duplicate contents. As illustrated in FIG. 11A, information distribution terminals 201 and 202 have identical contents “content A”. Further, the information distribution terminal 201 exists in a communication range 213 of an information reception terminal 203, and the information distribution terminals 201 and 202 exist in a communication range 214 of an information reception terminal 204.

In the information reception terminal 203, the information distribution terminal 201 is extracted as a terminal capable of distributing contents. Thus, the information reception terminal 203 displays a content list 303 including “content A” held by the information distribution terminal 201 as a list of distributable contents. In the information reception terminal 204, the information distribution terminals 201 and 202 are extracted as terminals capable of distributing contents. Therefore, a content list 304, in which “content A” held by both the information distribution terminals 201 and 202 is listed redundantly, is displayed in the information reception terminal 204.

As illustrated in FIG. 11B, there is a case in which the information distribution terminal 201 already exists in the communication range 213 of the information reception terminal 203 and then, the information distribution terminal 202 enters the communication range 213. In the information reception terminal 203 before the information distribution terminal 202 enters the communication range 213, a content list 303A including “content A” held by the information distribution terminal 201 is displayed. In the information reception terminal 203 after the information distribution terminal 202 enters the communication range 213, a content list 303B, in which “content A” held by both the information distribution terminals 201 and 202 is listed redundantly, is displayed.

In this way, display of the content list 304 or 303B, in which “content A” is listed redundantly, leads to a decrease in usability, such that a user may be confused when selecting a content, the number of other contents to be displayed may become smaller, or the like.

### BRIEF DESCRIPTION OF DRAWINGS

FIG. 1 is a diagram illustrating an exemplary information distribution system according to an embodiment;

FIG. 2 is a diagram illustrating an exemplary hardware configuration of a terminal device according to an embodiment;

FIG. 3 is a diagram illustrating an example of display of content information;

FIG. 4 is a diagram illustrating an exemplary functional configuration of an information distribution terminal according to an embodiment;

FIG. 5A is a flowchart illustrating an exemplary operation of an information distribution terminal according to an embodiment;

FIG. 5B is a flowchart illustrating an exemplary operation of an information distribution terminal according to an embodiment;

FIG. 6 is a diagram illustrating an exemplary functional configuration of an information reception terminal according to an embodiment;

FIG. 7 is a flowchart illustrating an exemplary operation of an information reception terminal according to an embodiment;

FIG. 8 is a diagram illustrating an exemplary operation of display of a content list;

FIG. 9 is a diagram illustrating an example of determination of a connection destination;

FIG. 10A is a diagram illustrating a connection between an information distribution terminal and an information reception terminal according to an embodiment;

FIG. 10B is a diagram illustrating a connection between an information distribution terminal and an information reception terminal according to an embodiment;

FIG. 10C is a diagram illustrating a connection between an information distribution terminal and an information reception terminal according to an embodiment;

FIG. 10D is a diagram illustrating a connection between an information distribution terminal and an information reception terminal according to an embodiment;

FIG. 11A is a diagram illustrating an example of redundant display of a content;

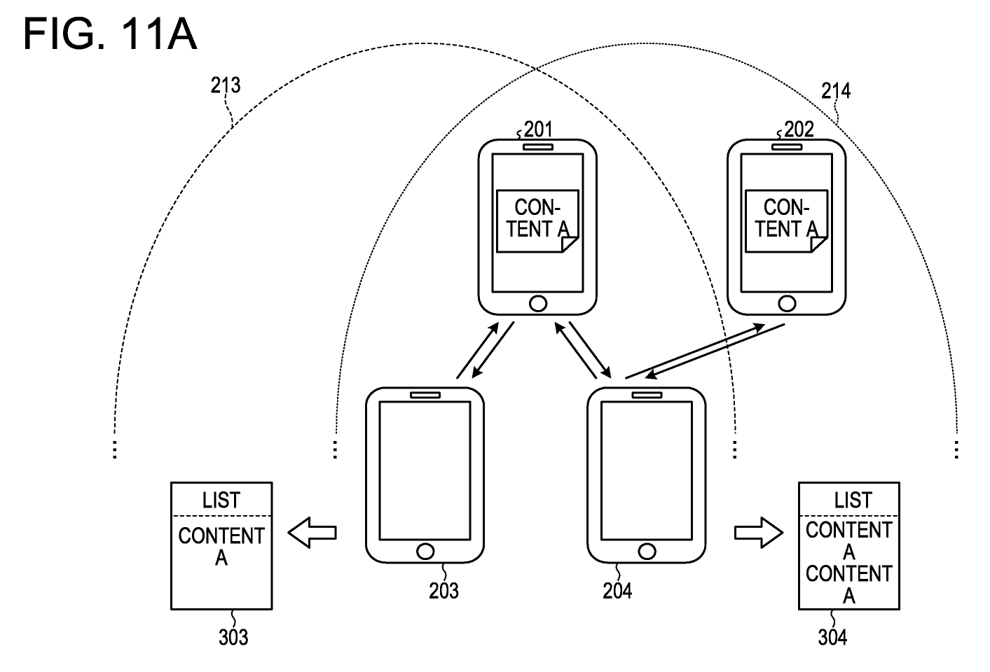

FIG. 11B is a diagram illustrating an example of redundant display of a content.

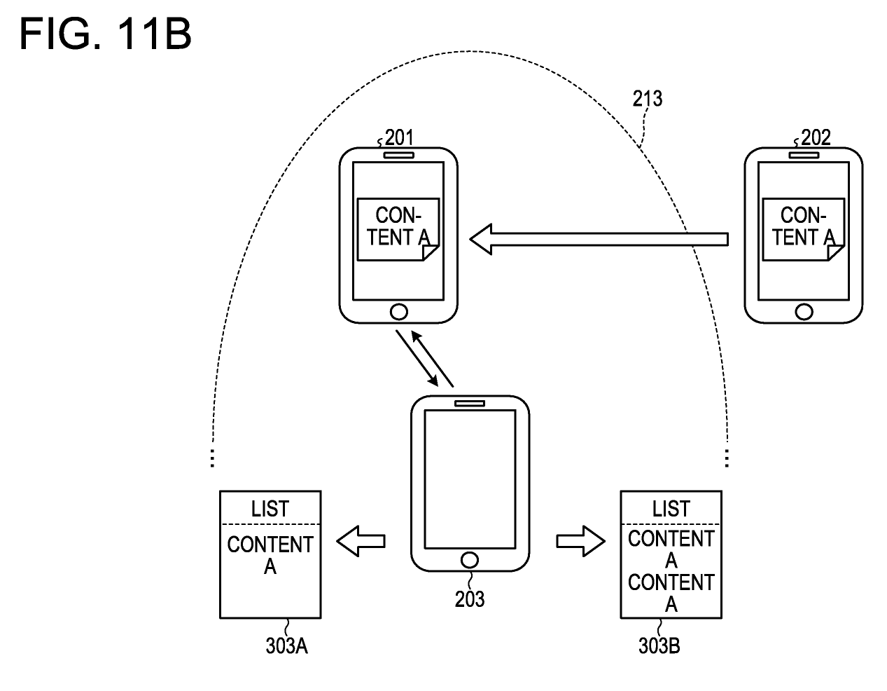

### DESCRIPTION OF EMBODIMENT

Hereinafter, an embodiment will be described with reference to the drawings. In the embodiment, components having a similar function will be denoted by similar reference numerals, and repeated descriptions thereof will be omitted. In addition, the following embodiment is only exemplary and is not intended to limit embodiments.

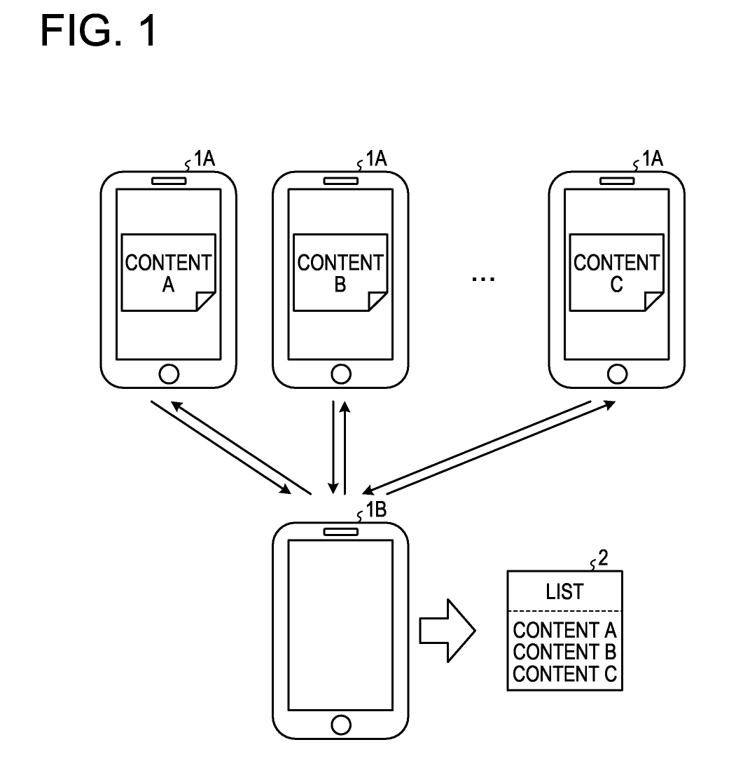

FIG. 1 is a diagram illustrating an exemplary information distribution system according to the embodiment. As illustrated in FIG. 1, the information distribution system uses wireless communication such as Wireless Fidelity (Wi-Fi) (registered trademark) direct communication, and distributes information (contents) between terminal devices 1 (1A, 1B) within each other's communication range of wireless communication. The terminal devices 1 may be, for example, smartphones, tablet terminals, or the like. The contents distributed by the terminal devices 1 include, for example, image data such as photographs or videos, document data such as texts, and the like.

Here, among the terminal devices 1, terminals that distribute contents are referred to as information distribution terminals 1A, and a terminal that receives the contents from the information distribution terminals 1A is referred to as an information reception terminal 1B.

When each of the information distribution terminals 1A and the information reception terminal 1B enter each other's communication range, the relevant information distribution terminal 1A and the information reception terminal 1B perform, for example, a device discovery response in the Wi-Fi direct communication. At this time, when responding to a request from the information reception terminal 1B, the relevant information distribution terminal 1A notifies the information reception terminal 1B of meta information including information about the contents which are distributable by the relevant information distribution terminal 1A.

The information reception terminal 1B generates a content list 2 (e.g., a list of content names) of contents that are distributable from the information distribution terminals 1A on the basis of the meta information notified from the information distribution terminals 1A. Subsequently, the information reception terminal 18 displays the generated content list 2 on a display or the like, and accepts selection of a content to be distributed, from among the contents listed in the content list 2. Upon accepting the selection, the information reception terminal 18 requests the corresponding information distribution terminal 1A to distribute the selected content. The corresponding information distribution terminal 1A distributes the content requested from the information reception terminal 18. The information reception terminal 18 displays the content distributed from the information distribution terminal 1A on a display or the like. In this way, a user of the information reception terminal 18 may confirm a desired content.

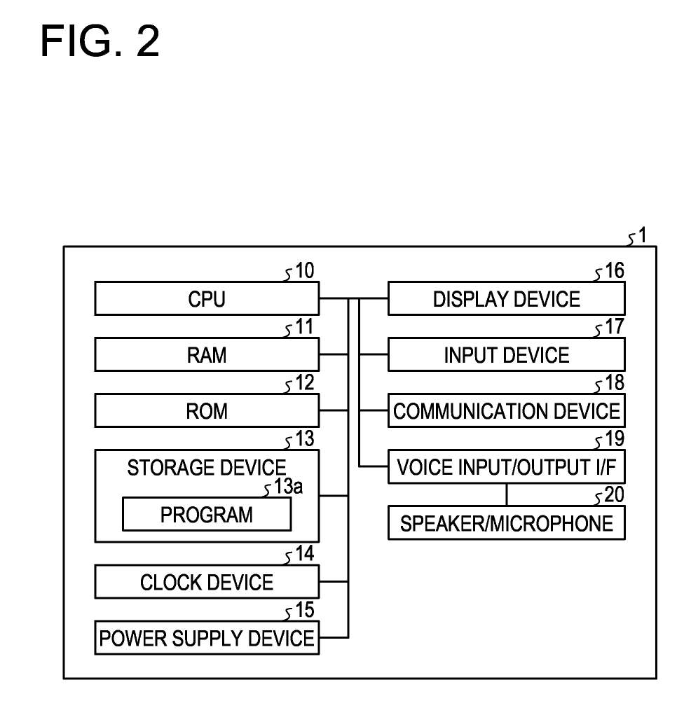

FIG. 2 is a diagram illustrating an exemplary hardware configuration of the terminal device 1 according to the embodiment. As illustrated in FIG. 2, the terminal device 1 includes a central processing unit (CPU) 10, a random access memory (RAM) 11, a read-only memory (ROM) 12, a storage device 13, a clock device 14, and a power supply device 15. The terminal device 1 also includes a display device 16, an input device 17, a communication device 18, a voice input/output interface (I/F) 19, and a speaker/microphone 20.

The CPU 10 is a processor that reads and executes a basic program stored in the ROM 12 or a program 13a stored in the storage device 13. The RAM 11 provides a work area for the CPU 10 to perform arithmetic processing. The ROM 12 stores therein the basic program to be executed by the CPU 10 and various pieces of setting data.

The storage device 13 is a storage device (e.g., a solid state drive (SSD)), and stores therein the program 13a and various setting data and various recorded data that are read or written when the program 13a is executed.

The clock device 14 is, for example, a real time clock (RTC), and measures time. The power supply device 15 supplies power supplied from a power supply such as a secondary battery or a commercial power supply to each component.

The display device 16 is a liquid crystal display or the like, and displays various screen images under the control of the CPU 10. The input device 17 is various operation keys, a touch panel superimposed on the screen of the display device 16, or the like, and is an input interface that accepts operations input from the user.

The communication device 18 performs wireless communication of various types of data such as voice or texts via an antenna (not illustrated) under the control of the CPU 10. Specifically, the communication device 18 performs wireless communication with another terminal device or a base station device existing within a communication range using a communication method such as long term evolution (LTE) communication, Wi-Fi communication, or the like. With this, the terminal device 1 performs voice communication (telephone call) or data communication of the contents or the like. The voice input/output I/F 19 inputs or outputs voice through the speaker/microphone 20 under the control of the CPU 10.

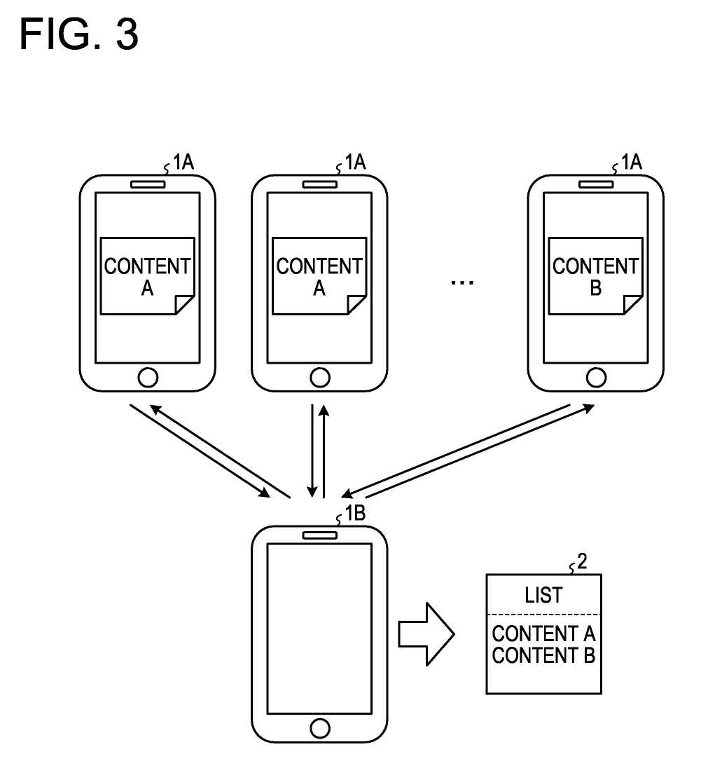

FIG. 3 is a diagram illustrating an example of display of content information. As illustrated in FIG. 3, the communication range of the information reception terminal 1B includes a plurality of information distribution terminals 1A capable of distributing “content A” or “content B”. It is assumed that there are two or more information distribution terminals 1A capable of distributing “content A”. Identification information such as a content identifier (ID) or a content name is set for each of the contents in accordance with a predetermined rule, and the same identification information is assigned for identical contents.

The information reception terminal 1B acquires meta information including identification information of a content from the plurality of information distribution terminals 1A within the communication range. The information reception terminal 1B determines, on the basis of the identification information of the contents, whether there are identical contents identified by the same identification information acquired from different information distribution terminals 1A (redundant information distribution terminals 1A). When it is determined that there are identical contents (“content A” illustrated in the example) identified by the same identification information, the information reception terminal 1B selects the content of any one of the redundant information distribution terminals 1A and generates the content list 2. Thus, in the information reception terminal 1B, the content list 2, in which “content A” is not redundantly listed, is displayed on the display device 16 as the content information of the distributable contents. In this manner, even when there are redundant information distribution terminals 1A capable of distributing identical contents within the communication range, the information reception terminal 1B may suppress the identical contents from being redundantly displayed.

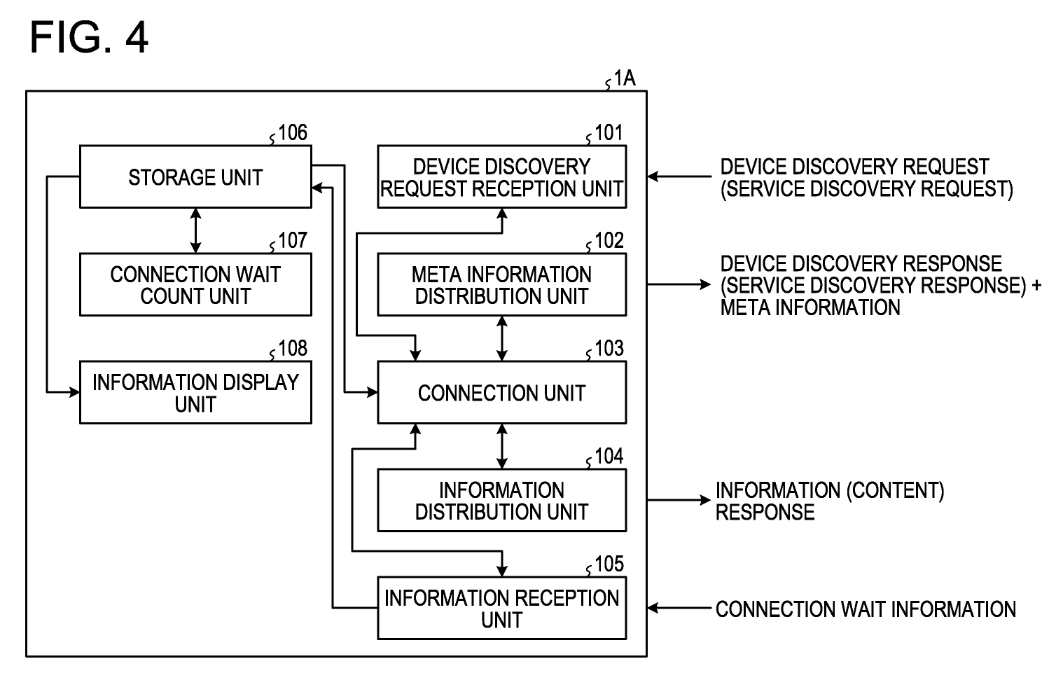

FIG. 4 is a diagram illustrating an exemplary functional configuration of the information distribution terminal 1A according to the embodiment. As illustrated in FIG. 4, the information distribution terminal 1A includes a device discovery request reception unit 101, a meta information distribution unit 102, a connection unit 103, an information distribution unit 104, an information reception unit 105, a storage unit 106, a connection wait count unit 107, and an information display unit 108. The functional configuration of the information distribution terminal 1A is implemented by causing the CPU 10 to execute the program 13a.

The device discovery request reception unit 101 receives a device discovery request from an information reception terminal 1B existing within a communication range of the communication device 18 of the information distribution terminal 1A. The device discovery request is one of Wi-Fi direct communication procedures and is used to discover a service (e.g., a content distribution service) between devices within each other's communication range and connect the devices to each other. The connection unit 103 is notified of the device discovery request received by the device discovery request reception unit 101.

The meta information distribution unit 102 distributes a device discovery response (service discovery response) to the device discovery request from the information reception terminal 18 via the communication device 18 under the control of the connection unit 103. Specifically, the meta information distribution unit 102 reads meta information including identification information of contents distributable by its own device and the number of connection waits, which is the number of other information reception terminals 18 that are waiting for establishment of a connection for content distribution, and responds to the information reception terminal 18 that has requested the device discovery.

The connection unit 103 is a component that controls establishment of a communication connection with the information reception terminal 18 which is performed via the communication device 18. Specifically, in response to the device discovery request received by the device discovery request reception unit 101, the connection unit 103 causes the meta information distribution unit 102 to distribute a device discovery response to the information reception terminal 18 of the request source. Further, in response to a content distribution request received by the information reception unit 105, the connection unit 103 reads a content requested to be distributed from the storage unit 106. Subsequently, the connection unit 103 causes the information distribution unit 104 to distribute the content read from the storage unit 106 to the information reception terminal 18 of the request source.

The information distribution unit 104 performs a response (distribution) of the content (information) to the content distribution request from the information reception terminal 18 under the control of the connection unit 103. Specifically, the information distribution unit 104 distributes the content read from the storage unit 106 in accordance with the content distribution request to the information reception terminal 18 of the request source via the communication device 18.

The information reception unit 105 receives information from an information reception terminal 1B existing in the communication range of the communication device 18. Specifically, the information reception unit 105 receives, from the information reception terminal 1B, connection wait information indicating that the information reception terminal 1B is waiting for establishment of connection (under communication connection) with the information distribution terminal 1A for content distribution, and stores the received connection wait information in the storage unit 106 together with time information indicating the time at which the connection wait information is received. The information reception unit 105 also receives, from the information reception terminal 1B, content distribution request in which a content to be distributed is specified by using content identification information. The connection unit 103 is notified of the received content distribution request.

The storage unit 106 stores and manages various types of information. Specifically, the storage unit 106 refers to (reads) or updates (writes) various types of information stored in the storage device 13. The various types of information to be referred to or updated by the storage unit 106 include the contents distributable by the information distribution terminals 1A and information on the contents, such as identification information set for the contents and the like. Also, the various types of information to be referred to or updated by the storage unit 106 include connection wait information indicating the information reception terminals 1B waiting for establishment of connection (under communication connection) with the information distribution terminal 1A for content distribution. Further, the various types of information to be referred to or updated by the storage unit 106 include the number of connection waits, which is the number of other terminal devices waiting for establishment of connection with the information distribution terminal 1A and which is counted on the basis of the connection wait information regarding a connection with the information distribution terminal 1A, which is received from the information reception terminals 1B.

The connection wait count unit 107 counts the number of connection waits in a past predetermined time period, which is the number of other terminal devices waiting for establishment of connection with the information distribution terminal 1A. Specifically, upon the connection wait information received by the information reception unit 105 from the information reception terminal 18 and the time information thereof being stored in the storage unit 106, the connection wait count unit 107 increments the number of connection waits, which is stored in the storage unit 106. In addition, upon the device discovery request reception unit 101 receiving a device discovery request, the connection wait count unit 107 discards connection wait information that is determined, on the basis of the time information stored together with the connection wait information, to elapse a predetermined time (i.e., timed out), and decrements the number of connection waits stored in the storage unit 106.

The information display unit 108 is a component that performs display on the display device 16. For example, the information display unit 108 reads various types of information such as contents stored in the storage unit 106 so as to display the information on the display device 16.

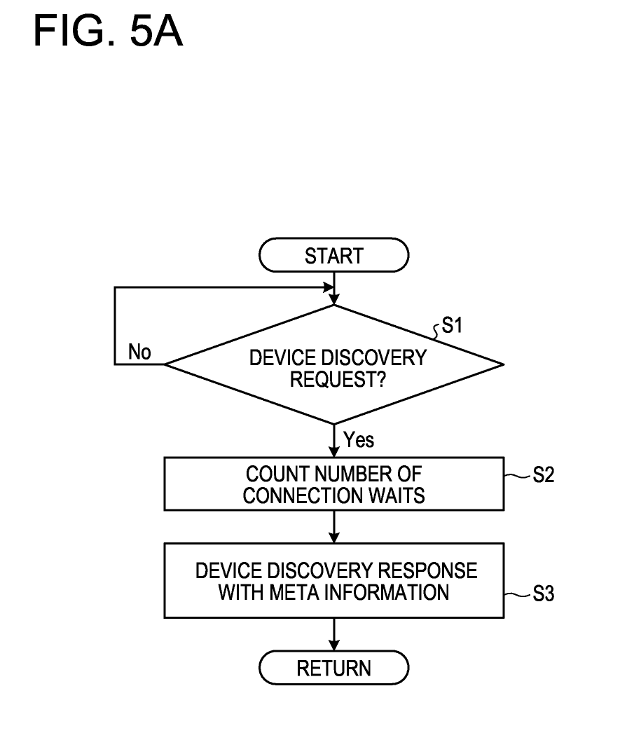

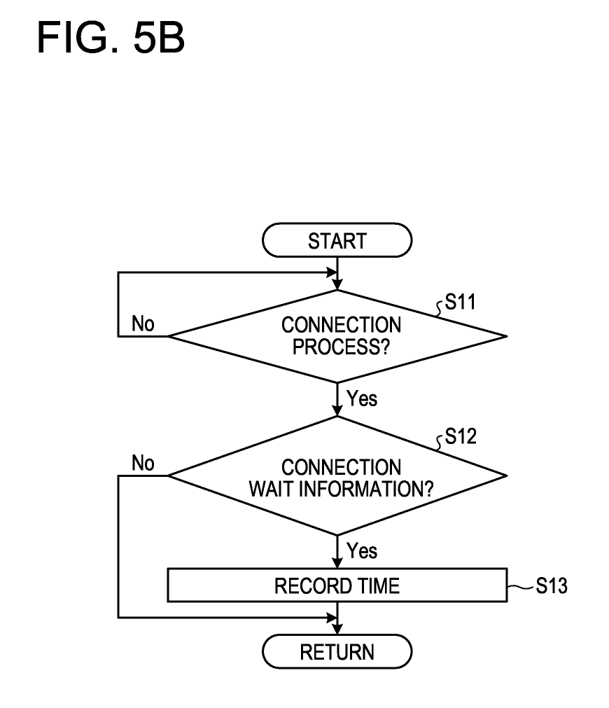

FIGS. 5A and 5B are flowcharts illustrating exemplary operations of the information distribution terminal 1A according to the embodiment. FIG. 5A is an exemplary process related to a device discovery response, and FIG. 5B is an exemplary process related to reception of connection wait information.

As illustrated in FIG. 5A, once the process is initiated, the device discovery request reception unit 101 determines whether or not a device discovery request (service discovery request) is received from an information reception terminal 18 existing in the communication range of the communication device 18 (51). When it is determined that no device discovery request is received (No in 51), the device discovery request reception unit 101 repeats 51.

When it is determined that a device discovery request is received (Yes in 51), the connection wait count unit 107 counts the number of connection waits in the past predetermined time period, which is the number of other terminal devices waiting for establishment of connection with the information distribution terminal 1A, on the basis of the connection wait information stored in the storage unit 106 (S2). Subsequently, the meta information distribution unit 102 reads the meta information including the identification information of distributable contents and the counted number of connection waits under the control of the connection unit 103, and responds to the information reception terminal 1B that has requested the device discovery (S3).

As illustrated in FIG. 5B, when the process is initiated, the information reception unit 105 determines whether or not a connection process has been performed by communication from an information reception terminal 1B existing in the communication range of the communication device 18 (S11). When it is determined that no connection process has been performed (No in S11), the information reception unit 105 repeats S11.

When it is determined that a connection process has been performed (Yes in S11), the information reception unit 105 determines whether or not connection wait information has been received, that is, whether or not it has been notified from the information reception terminal 1B that the information reception terminal 1B is waiting for establishment of connection with the information distribution terminal 1A (S12). When it is determined that it has been notified that the information reception terminal 1B is waiting for establishment of connection with the information distribution terminal 1A (the connection wait information has been received) (Yes in S12), the time at which the connection wait information is received is recorded together with the connection wait information (e.g., the communication address of the information reception terminal 1B) indicating the information reception terminal 1B in the storage unit 106 (S13).

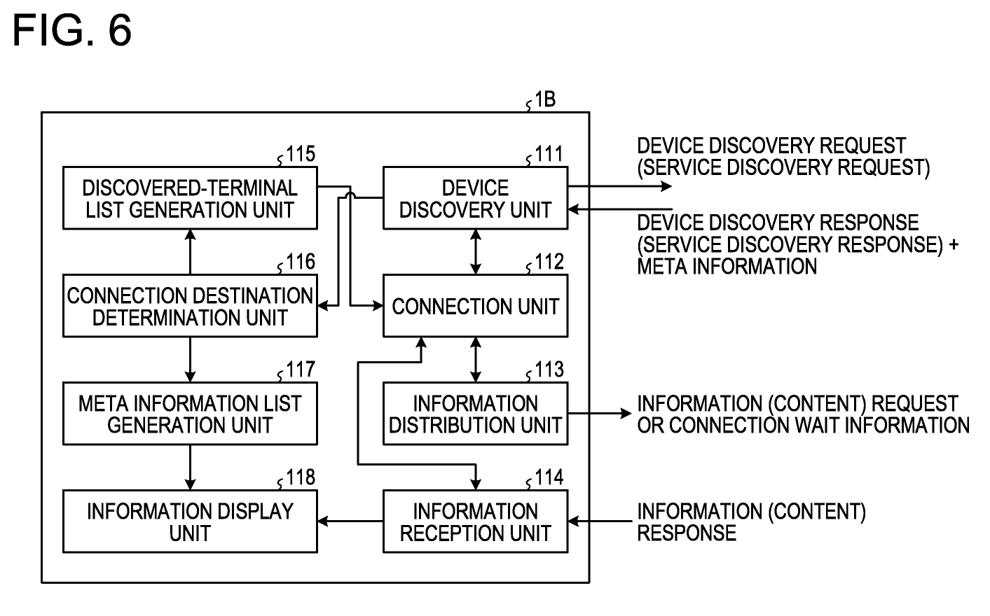

FIG. 6 is a diagram illustrating an exemplary functional configuration of an information reception terminal 1B according to the embodiment. As illustrated in FIG. 6, the information reception terminal 1B includes a device discovery unit 111, a connection unit 112, an information distribution unit 113, an information reception unit 114, a discovered-terminal list generation unit 115, a connection destination determination unit 116, a meta information list generation unit 117, and an information display unit 118. The functional configuration of the information reception terminal 18 is implemented by causing the CPU 10 to execute the program 13a.

The device discovery unit 111 transmits a device discovery request (service discovery request) to an information distribution terminal 1A existing in the communication range of the communication device 18 under the control of the connection unit 112, and performs a process of receiving a device discovery response (service discovery response) from the information distribution terminal 1A. Specifically, the device discovery unit 111 transmits a device discovery request by Wi-Fi direct communication to an information distribution terminal 1A existing in the communication range of the communication device 18. Subsequently, the device discovery unit 111 receives a device discovery response including meta information and the number of connection waits from the information distribution terminal 1A to which the device discovery request is transmitted. The connection destination determination unit 116 is notified of the device discovery response received by the device discovery unit 111 determination unit.

The connection unit 112 is a component that controls communication connection with the information distribution terminal 1A which is performed via the communication device 18. Specifically, the connection unit 112 causes the information distribution unit 113 to distribute a content distribution request for the content which is selected from the content list 2 and requested to be distributed to the information distribution terminal 1A. The connection unit 112 also causes the information distribution unit 113 to distribute the connection wait information to the information distribution terminal 1A related to the content included in the content list 2.

The information distribution unit 113 distributes a content distribution request for a content selected from the content list 2 to the information distribution terminal 1A under the control of the connection unit 112. Specifically, the information distribution unit 113 distributes a content distribution request including identification information indicating the content for which distribution is requested, to the information distribution terminal 1A via the communication device 18.

Also, the information distribution unit 113 distributes connection wait information to the information distribution terminal 1A that distributes the content included in the content list 2 via the communication device 18 under the control of the connection unit 112. As a result, the information distribution terminal 1A may recognize that the information reception terminal 1B is waiting for establishment of connection (under communication connection) with the information distribution terminal 1A for the content distribution of a content listed in the content list 2.

The information reception unit 114 receives a response of the content (information) from an information distribution terminal 1A existing in the communication range of the communication device 18 under the control of the connection unit 112. Specifically, the information reception unit 114 receives the content distributed from the information distribution terminal 1A in response to a request from the information reception terminal 1B, and outputs the received content to the information display unit 118.

The discovered-terminal list generation unit 115 prepares a list of information distribution terminals 1A that are discovered by using the device discovery request and determined as connection destinations by the connection destination determination unit 116, on the basis of a notification from the connection destination determination unit 116. The connection unit 112 is notified of the list of the connection destinations prepared by the discovered-terminal list generation unit 115. The connection unit 112 causes the information distribution unit 113 to distribute connection wait information to the information distribution terminals 1A included in the list of the connection destinations.

The connection destination determination unit 116 determines an information distribution terminal 1A to be connected, on the basis of the information (device discovery response) acquired from each of the information distribution terminals 1A within the communication range of the communication device 18 by the device discovery request, and notifies the discovered-terminal list generation unit 115 and the meta information list generation unit 117 of the determined connection destination. Specifically, the connection destination determination unit 116 determines an information distribution terminal 1A having a distributable content as a connection destination, on the basis of the meta information acquired from the information distribution terminals 1A.

At this time, when there are contents identified by the same identification information included in the meta information acquired from redundant information distribution terminals 1A within the communication range of the communication device 18, the connection destination determination unit 116 selects any one of the redundant information distribution terminals 1A. Specifically, the connection destination determination unit 116 selects an information distribution terminal 1A having the smallest number of connection waits among the redundant information distribution terminals 1A.

The meta information list generation unit 117 generates the content list 2 of distributable contents on the basis of the notification from the connection destination determination unit 116. Specifically, the meta information list generation unit 117 generates the content list 2 enumerating content names, content IDs, or the like of contents distributable from connection destinations, on the basis of the meta information of the information distribution terminal 1A determined as the connection destination by the connection destination determination unit 116. The generated content list 2 is output to the information display unit 118.

The information display unit 118 is a component that performs display on the display device 16. For example, the information display unit 118 displays the content list 2 generated by the meta information list generation unit 117 on the display device 16. The information display unit 118 also displays a content, which is distributed by an information distribution terminal 1A and received by the information reception unit 114, on the display device 16.

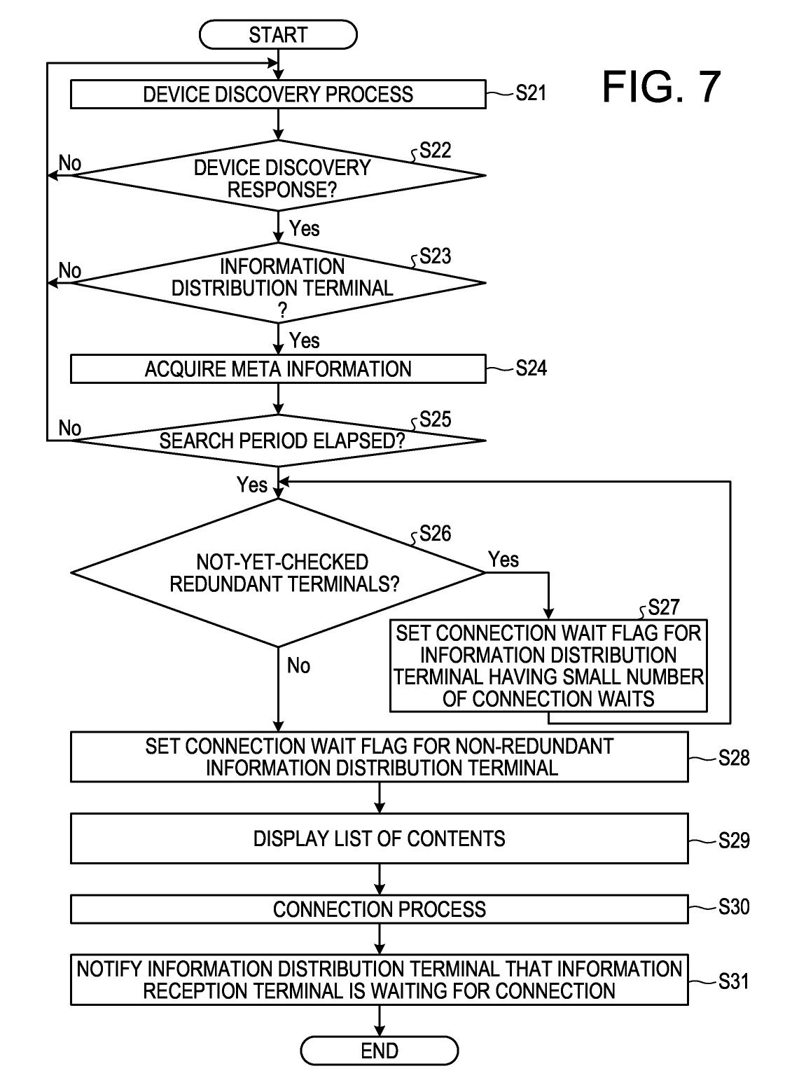

FIG. 7 is a flowchart illustrating an exemplary operation of an information reception terminal 18 according to the embodiment. As illustrated in FIG. 7, when the process is initiated, the device discovery unit 111 performs a device discovery process of transmitting a device discovery request to an information distribution terminal 1A existing in the communication range of the communication device 18 and receiving a device discovery response from the information distribution terminal 1A (S21).

Subsequently, the device discovery unit 111 determines whether or not a device discovery response (service discovery response) is received from the information distribution terminal 1A existing in the communication range (S22). When it is determined that no device discovery response is received (No in S22), the device discovery unit 111 returns to S21.

When it is determined that a device discovery response is received (Yes in S22), the device discovery unit 111 determines whether or not the discovered device is an information distribution terminal 1A that distributes a content, on the basis of the response content (S23). For example, when the response includes meta information of a distributable content, the device discovery unit 111 determines that the device is an information distribution terminal 1A.

Subsequently, the device discovery unit 111 acquires meta information transmitted from the discovered information distribution terminal 1A. The device discovery unit 111 adds the acquired meta information together with the identification information (e.g., communication address) of the information distribution terminal 1A to the meta information list stored in the work area secured in the RAM 11 (S24).

Subsequently, the device discovery unit 111 determines whether or not a search period (T) preliminarily set for the device discovery has elapsed (S25). When it is determined that the search period (T) has not elapsed (No in S25), the device discovery unit 111 returns to S21 since there is a possibility that a not-yet-responding information distribution terminal 1A may exist.

When it is determined that the search period (T) has elapsed (Yes in S25), the device discovery unit 111 terminates the device discovery process and proceeds to S26 since there is little possibility that a not-yet-responding information distribution terminal 1A may exist.

In S26 to S28, the connection destination determination unit 116 refers to the meta information list secured in the RAM 11 and performs a connection destination determination process of determining the information distribution terminal 1A to be connected, among the information distribution terminals 1A within the communication range of the communication device 18. It is assumed that, for the information distribution terminal 1A determined to be connected in the connection destination determination process, a flag (connection wait flag) indicating that the terminal is to be connected is set.

Specifically, the connection destination determination unit 116 determines, on the basis of the connection wait flag, whether or not there are redundant information distribution terminals 1A including the same content ID in the meta information thereof in the meta information list, for which the connection destination determination process has not been performed (S26). That is, in S26, it is determined whether or not any one information distribution terminal 1A has been selected for the information distribution terminals 1A having identical contents identified by the same content identification information.

When it is determined that there are redundant information distribution terminals 1A for which the connection destination determination process has not been performed, that is, selection of an information distribution terminal 1A as a connection destination has not been performed (Yes in S26), the connection destination determination unit 116 sets the connection wait flag for the information distribution terminal 1A having the smallest number of connection waits among the redundant information distribution terminals 1A, on the basis of the number of connection waits notified from the redundant information distribution terminals 1A (S27).

When it is determined that there are no redundant information distribution terminals 1A for which the connection destination determination process has not been performed, that is, selection of an information distribution terminal 1A as a connection destination has been performed for all redundant information distribution terminals 1A (No in S26), the connection destination determination unit 116 sets the connection wait flag for non-redundant information distribution terminals 1A each of which includes a content ID, in the meta information thereof, which is different from a content ID included in the meta information of any other information distribution terminal 1A (S28).

Subsequently, the meta information list generation unit 117 generates a content list 2 enumerating the content names, content IDs, or the like of contents distributable from the connection destinations, on the basis of the information (a portion of the meta information) of the information distribution terminals 1A for which the connection wait flag is set. Subsequently, the information display unit 118 displays the generated content list 2 on the display device 16 (S29).

Subsequently, the connection unit 112 performs a connection process on the information distribution terminal 1A for which the connection wait flag is set (S30). Specifically, the connection unit 112 causes the information distribution unit 113 to distribute connection wait information to the information distribution terminal 1A for which the connection wait flag is set to inform the information distribution terminal 1A that the information reception terminal 1B is waiting for establishment of connection with the information distribution terminal 1A (S31).

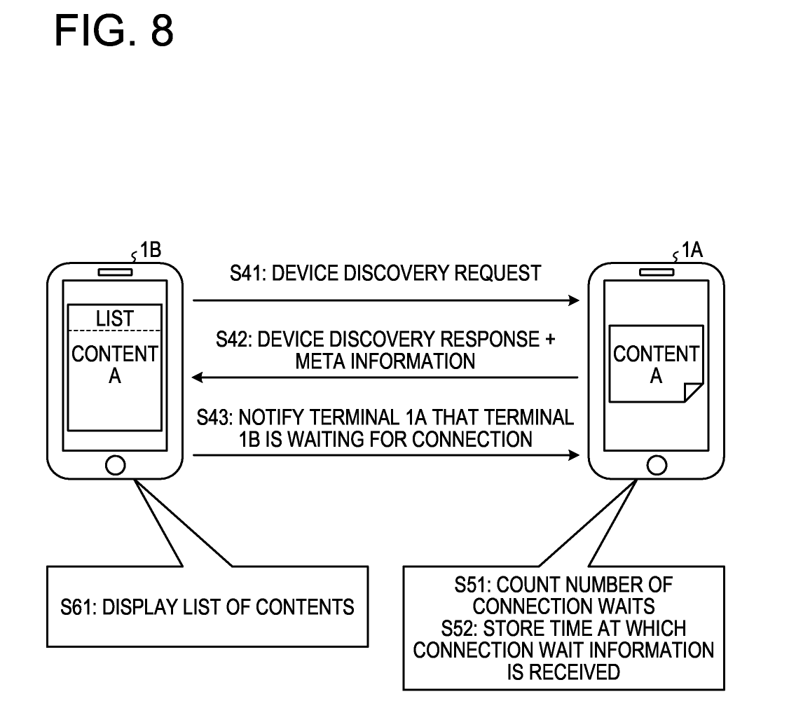

FIG. 8 is a diagram illustrating an exemplary operation of display of the content list. As illustrated in FIG. 8, an information distribution terminal 1A is notified of a device discovery request from an information reception terminal 1B (S41). The information reception terminal 1B is notified of a device discovery response from the information distribution terminal 1A which has received the device discovery request (S42). At this time, the information reception terminal 1B is notified of meta information (content IDs indicating distributable contents, the number of connection waits, and the like) from the information distribution terminal 1A.

The information reception terminal 1B determines an information distribution terminal 1A that distributes a content to be displayed in the list on the basis of the content IDs and the number of connection waits notified together with the device discovery response, and displays the list of contents (S61). Specifically, when the same content ID is notified from a plurality of information distribution terminals 1A, an information distribution terminal 1A having the smallest number of connection waits is selected from among the plurality of information distribution terminals 1A and displayed in the list. Thus, the information reception terminal 1B may suppress identical contents from being redundantly displayed even when there are a plurality of information distribution terminals 1A capable of distributing the identical contents within the communication range. Further, the information reception terminal 1B may suppress the deviation of the number of connection waits between the information distribution terminals 1A having the identical contents by selecting the information distribution terminal 1A having the smallest number of connection waits among the information distribution terminals 1A having the identical contents.

Subsequently, the information distribution terminal 1A having the content displayed in the list is notified of the connection wait information from the information reception terminal 1B, that is, the information distribution terminal 1A is notified that the information reception terminal 1B is waiting for establishment of connection with the information distribution terminal 1A for content distribution (S43).

The information distribution terminal 1A counts the number of connection waits in the past predetermined time period (S51), and notifies the information reception terminal 1B of the counted number of connection waits at the time of making a device discovery response. Further, when the information distribution terminal 1A receives the connection wait information from the information reception terminal 1B, the information distribution terminal 1A stores, in the storage unit 106, the connection wait information and the time at which the connection wait information is received (S52).

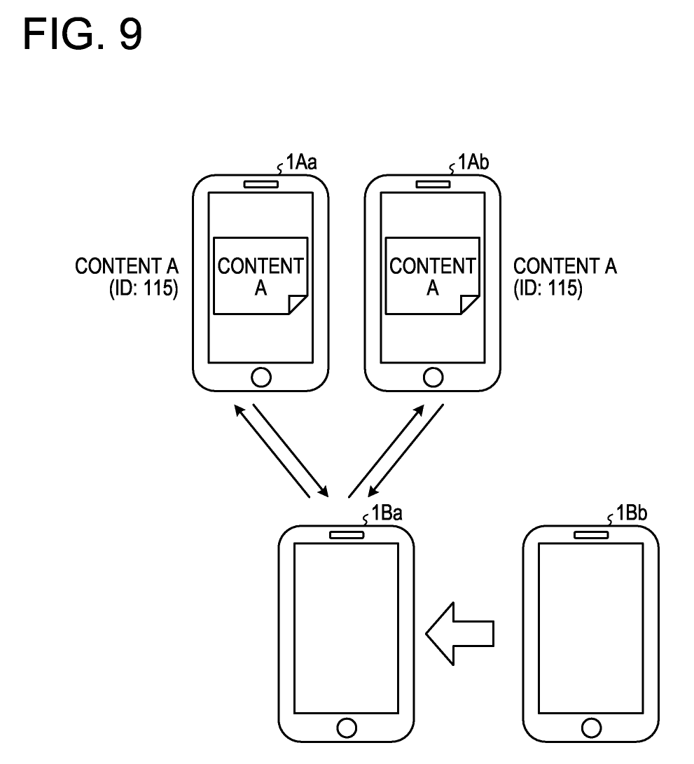

FIG. 9 is a diagram illustrating an example of the determination of a connection destination. As illustrated in FIG. 9, it is assumed that both information distribution terminals 1Aa and 1Ab have identical contents “content A” of which the ID is “115”. It is also assumed that the information distribution terminals 1Aa and 1Ab and an information reception terminal 1Ba are within each other's communication range.

The information reception terminal 1Ba selects one of the information distribution terminals 1Aa and 1Ab to generate and display a content list 2 including “content A”, on the basis of meta information acquired from the information distribution terminals 1Aa and 1Ab. At this time, it is assumed that the number of connection waits of both the information distribution terminals 1Aa and 1Ab is “0”. Thus, in this case, the selection is performed randomly. In the illustrated example, it is assumed that the information distribution terminal 1Aa is selected. With this selection, the information distribution terminal 1Aa is notified of connection wait information from the information reception terminal 1Ba, and the number of connection waits in the information distribution terminal 1Aa becomes “1”.

Subsequently, it is assumed that an information reception terminal 1Bb has moved and the information distribution terminals 1Aa and 1Ab and the information reception terminal 1Bb are within each other's communication range. The information reception terminal 1Bb selects one of the information distribution terminals 1Aa and 1Ab to generate and display a content list 2 including “content A”, on the basis of meta information acquired from the information distribution terminals 1Aa and 1Ab. At this time, the number of connection waits of the information distribution terminal 1Aa is “1” and the number of connection waits of the information distribution terminal 1Ab is “0”. Thus, in the information reception terminal 1Bb, the information distribution terminal 1Ab is selected as the connection destination. With this selection, the information distribution terminal 1Ab is notified of the connection wait information from the information reception terminal 1Bb, and the number of connection waits in the information distribution terminal 1Ab becomes “1”.

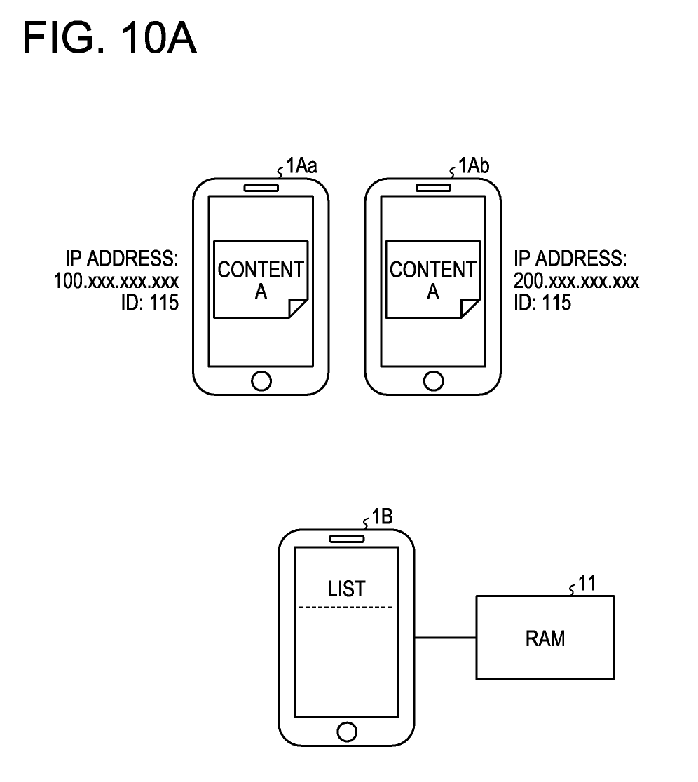

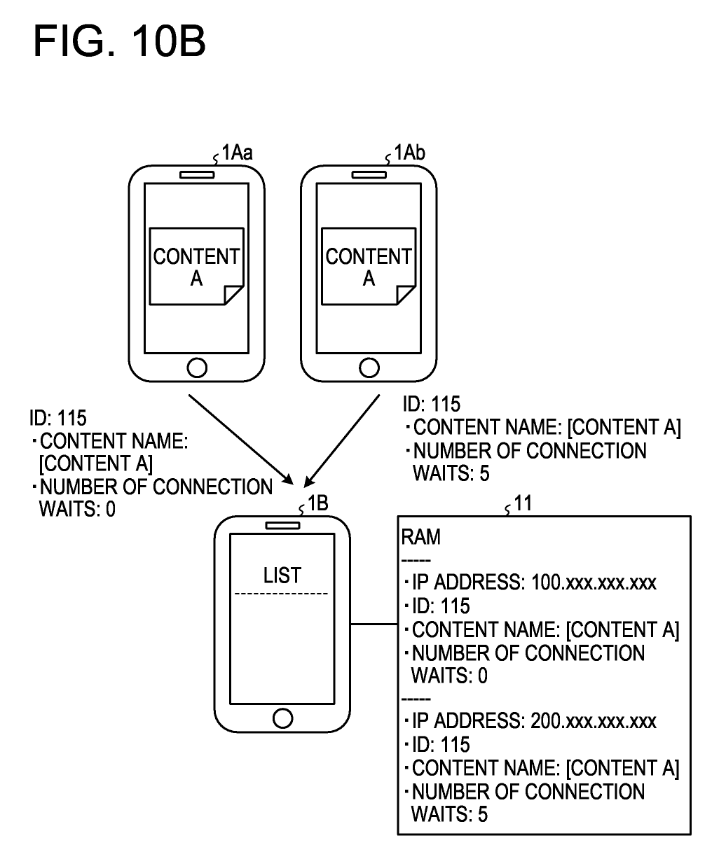

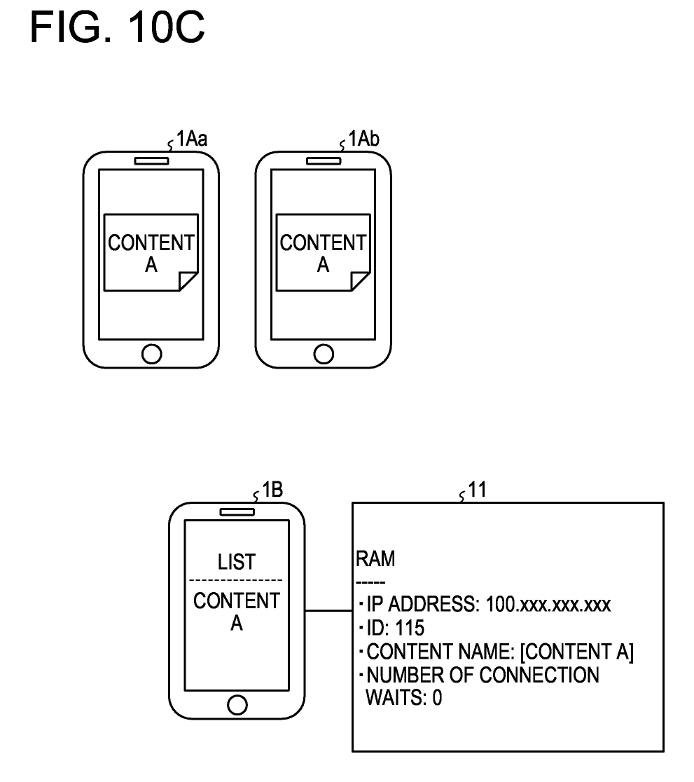

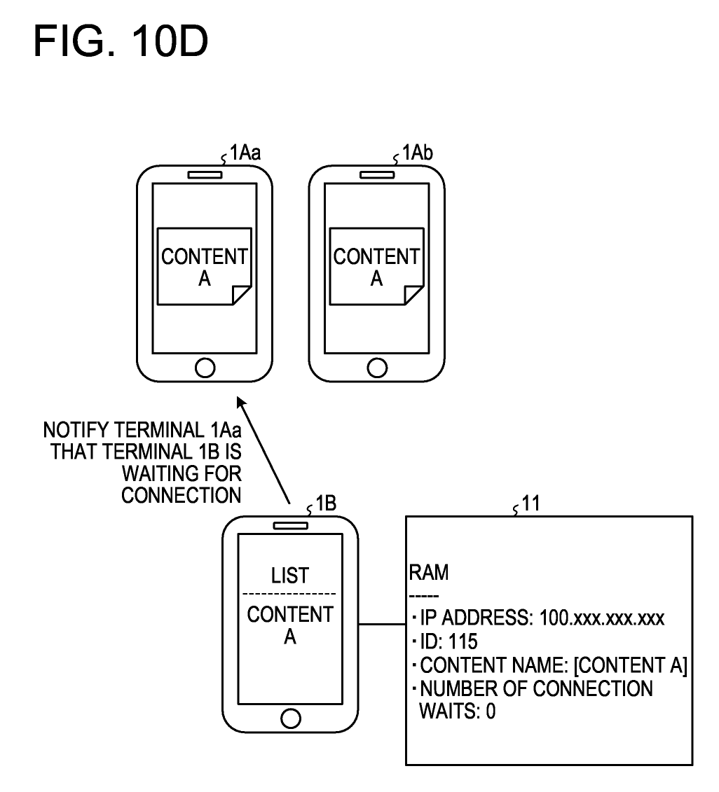

FIGS. 10A to 10D are diagrams illustrating connections between the information distribution terminals 1Aa and 1Ab and the information reception terminal 1B according to the embodiment. As illustrated in FIGS. 10A to 10D, it is assumed that the information distribution terminals 1Aa and 1Ab have identical contents “content A” of which the ID is “115”. It is also assumed that the information distribution terminals 1Aa and 1Ab and the information reception terminal 1B are within each other's communication range.

Further, as illustrated in FIG. 10A, it is assumed that, before the information distribution terminals 1Aa and 1Ab and the information reception terminal 1B are connected to each other, the RAM 11 of the information reception terminal 1B holds no information received from the information distribution terminals 1Aa and 1Ab and is empty.

As illustrated in FIG. 10B, the information reception terminal 1B acquires meta information from the information distribution terminals 1Aa and 1Ab within the communication range of the communication device 18, and stores the meta information in the meta information list for each information distribution terminal in the RAM 11. Specifically, for the information distribution terminal 1Aa, the meta information (the ID and the content name) of “content A” and the number of connection waits of “0” are stored in the meta information list in the RAM 11 together with the internet protocol (IP) address. Further, for the information distribution terminal 1Ab, the meta information (the ID and the content name) of “content A” and the number of connection waits of “5” are stored in the meta information list in the RAM 11 together with the IP address.

The information reception terminal 18 selects one of the information distribution terminals 1Aa and 1Ab, and generates and displays the content list 2 including “content A”, on the basis of the meta information lists. At this time, the number of connection waits of the information distribution terminal 1Aa is “0” and the number of connection waits of the information distribution terminal 1Ab is “5”. Thus, as illustrated in FIG. 10C, the information reception terminal 18 selects the information distribution terminal 1Aa as a connection destination, and updates the list in the RAM 11. Subsequently, as illustrated in FIG. 10D, the information reception terminal 18 notifies the information distribution terminal 1Aa, which is selected as the connection destination, of the connection wait information and notifies that the information reception terminal 18 is waiting for establishment of connection with the information distribution terminal 1Aa.

As described above, the information reception terminal 18 includes the connection unit 112 that wirelessly communicates with an information distribution terminal 1A within the communication range of the communication device 18. The information reception terminal 18 includes the device discovery unit 111 that acquires, from the information distribution terminal 1A, meta information including identification information of a content distributed by the information distribution terminal 1A. The information reception terminal 18 includes the meta information list generation unit 117 that generates the content list 2 of distributable contents, on the basis of the meta information acquired from each of the information distribution terminals 1A within the communication range. The information reception terminal 18 includes the information display unit 118 that displays the generated content list 2. When there are identical contents identified by the same identification information acquired from different information distribution terminals 1A (redundant information distribution terminals 1A) within the communication range, the meta information list generation unit 117 selects the content of one of the information distribution terminals 1A in accordance with the determination of the connection destination determination unit 116, and generates the content list 2. Therefore, even when there are redundant information distribution terminals 1A capable of distributing identical contents within the communication range, the information reception terminal 1B may suppress the identical contents from being redundantly displayed.

All examples and conditional language recited herein are intended for pedagogical purposes to aid the reader in understanding the disclosure and the concepts contributed by the inventor to furthering the art, and are to be construed as being without limitation to such specifically recited examples and conditions, nor does the organization of such examples in the specification relate to a showing of the superiority and inferiority of the disclosure. Although the embodiment of the present disclosure has been described in detail, it should be understood that the various changes, substitutions, and alterations could be made hereto without departing from the spirit and scope of the disclosure.

What is claimed is:

1. An information reception terminal, comprising:
a memory; and
a processor coupled to the memory and the processor configured to:
acquire meta information from each of a plurality of information distribution terminals existing within a communication range of the information reception terminal, the meta information including identification information identifying a content distributed by the relevant information distribution terminal;
generate a list of contents on basis of the meta information acquired from each of the plurality of information distribution terminals; and
display the generated list on a display device,
wherein
the processor is configured to:
select a content distributed by one of different information distribution terminals of the plurality of information distribution terminals to list the selected content in the list when there are identical contents identified by same identification information included in first pieces of meta information acquired from the different information distribution terminals.

2. The information reception terminal according to claim 1, wherein
the processor is configured to:
notify a first information distribution terminal of the plurality of information distribution terminals that the information reception terminal is waiting for connection with the first information distribution terminal, the first information distribution terminal distributing a content listed in the list.

3. The information reception terminal according to claim 2, wherein
the meta information includes a number of connection waits which is a number of information reception terminals waiting for connection with the relevant information distribution terminal, and
the processor is configured to:
select, on basis of the meta information acquired from the different information distribution terminals, a content distributed by a second information distribution terminal of the different information distribution terminals, the second information distribution terminal having a smallest number of connection waits among the different information distribution terminals to list the selected content in the list.

4. The information reception terminal according to claim 1, wherein
the processor is configured to:
wirelessly communicate with the plurality of information distribution terminals via Wi-Fi direct communication.

5. The information reception terminal according to claim 4, wherein
the processor is configured to:
acquire the meta information by a device discovery response in the Wi-Fi direct communication.

6. An information distribution system, comprising:
a plurality of information distribution terminals; and
an information reception terminal,
wherein each of the plurality of information distribution terminals includes
a first processor configured to
distribute meta information to the information reception terminal in response to a request received from the information reception terminal, the meta information including identification information identifying a content distributed by the relevant information distribution terminal, the information reception terminal existing within a communication range of the relevant information distribution terminal,
wherein the information reception terminal includes
a second processor configured to:
acquire the meta information from each of the plurality of information distribution terminals existing within a communication range of the information reception terminal;
generate a list of contents on basis of the meta information acquired from each of the plurality of information distribution terminals; and
display the generated list on a display device,
wherein the second processor is configured to:
select a content distributed by one of different information distribution terminals of the plurality of information distribution terminals to list the selected content in the list when there are identical contents identified by same identification information included in first pieces of meta information acquired from the different information distribution terminals.

7. The information distribution system according to claim 6, wherein
the second processor is configured to:
notify a first information distribution terminal of the plurality of information distribution terminals that the information reception terminal is waiting for connection with the first information distribution terminal, the first information distribution terminal distributing a content listed in the list.

8. The information distribution system according to claim 7, wherein
the meta information includes a number of connection waits which is a number of information reception terminals waiting for connection with the relevant information distribution terminal, and
the second processor is configured to:
select, on basis of the meta information acquired from the different information distribution terminals, a content distributed by a second information distribution terminal of the different information distribution terminals, the second information distribution terminal having a smallest number of connection waits among the different information distribution terminals to list the selected content in the list.

9. The information distribution system according to claim 6, wherein
the second processor is configured to:
wirelessly communicate with the plurality of information distribution terminals via Wi-Fi direct communication.

10. The information distribution system according to claim 9, wherein
the second processor is configured to:
acquire the meta information by a device discovery response in the Wi-Fi direct communication.

11. A non-transitory computer-readable recording medium having stored therein a program that causes a computer to execute a process, the process comprising:
acquiring meta information from each of a plurality of information distribution terminals existing within a communication range of the information reception terminal, the meta information including identification information identifying a content distributed by the relevant information distribution terminal;
generating a list of contents on basis of the meta information acquired from each of the plurality of information distribution terminals; and
displaying the generated list on a display device,
wherein
the generating includes:
selecting a content distributed by one of different information distribution terminals of the plurality of information distribution terminals to list the selected content in the list when there are identical contents identified by same identification information included in first pieces of meta information acquired from the different information distribution terminals.

12. The non-transitory computer-readable recording medium according to claim 11, wherein
the process further includes:
notifying a first information distribution terminal of the plurality of information distribution terminals that the information reception terminal is waiting for connection with the first information distribution terminal, the first information distribution terminal distributing a content listed in the list.

13. The non-transitory computer-readable recording medium according to claim 12, wherein
the meta information includes a number of connection waits which is a number of information reception terminals waiting for connection with the relevant information distribution terminal, and
the process further includes:
selecting, on basis of the meta information acquired from the different information distribution terminals, a content distributed by a second information distribution terminal of the different information distribution terminals, the second information distribution terminal having a smallest number of connection waits among the different information distribution terminals to list the selected content in the list.

14. The non-transitory computer-readable recording medium according to claim 11, wherein
the process further includes:
wirelessly communicating with the plurality of information distribution terminals via Wi-Fi direct communication.

15. The non-transitory computer-readable recording medium according to claim 14, wherein
the process further includes:
acquiring the meta information by a device discovery response in the Wi-Fi direct communication.
